(19) United States
(12) Patent Application Publication
(10) Pub. No.: US 2022/0059098 A1
(43) Pub. Date: Feb. 24, 2022

(54) DYNAMIC ELECTRONIC AGREEMENTS

(71) Applicant: Verified Technologies, Inc., Orland Park, IL (US)

(72) Inventors: Joseph M. Ruzevich, Orland Park, IL (US); Denise A. Ruzevich, Orland Park, IL (US); Joseph J. Ruzevich, Orland Park, IL (US)

(21) Appl. No.: 17/410,413

(22) Filed: Aug. 24, 2021

Related U.S. Application Data
(60) Provisional application No. 63/069,319, filed on Aug. 24, 2020.

(51) Int. Cl. G10L 17/24; G06F 21/45; G10L 17/26; G10L 25/03; G06Q 30/06

(52) U.S. Cl. CPC G10L 17/24; G06F 21/45; G06Q 30/0601; G10L 25/03; G10L 17/26

(57) ABSTRACT

A method for dynamically recording an agreement includes receiving, from a first electronic communication device, a safe word; receiving, from the first electronic communication device, a voice signature from a user of the first electronic communication device; sending, to the first electronic communication device, a unique code to display on the first electronic communication device; receiving, from a second electronic communication device, a scan of the unique code on the first electronic communication device; receiving, from the second electronic communication device, a voice signature from a user of the second electronic communication device; initiating audio recording on at least one of the first electronic communication device and the second electronic communication device, and receiving recorded audio of the audio recording; storing the recorded audio at a central system, and providing access to the recorded audio.

### CROSS-REFERENCE TO THE RELATED APPLICATION

This U.S. nonprovisional patent application claims the benefit of priority to Provisional U.S. patent application Ser. No. 63/069,319, filed on Aug. 24, 2020 in the United States Patent and Trademark Office, the contents of which are herein incorporated by reference in their entirety.

### BACKGROUND

Once provided with sufficient processing and memory capabilities, electronic devices have been used to implement many different types of software applications for communications, entertainment and more. Software applications have been able to address many types of problems encountered by individuals in modern society, and some such software applications provide solutions to complex technical problems in order to address problems encountered by individuals as intended.

One such problem encountered by individuals is an inability to safely record electronic agreements on a dynamic basis for matters both large and small. Oftentimes, a party to an agreement may be intimidating to another party to the agreement, such that an agreement may only be reached under duress. In other circumstances, an agreement that was reached without duress will still be questioned afterwards by a party either falsely denying the agreement or falsely asserting that the agreement was reached under duress.

Accordingly, dynamic electronic agreements as described herein provides mechanisms for parties to safely record an agreement using electronic devices and communication networks and in a manner in which both the agreement and the absence of duress may be demonstrated later.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A illustrates a network overview for dynamic electronic agreements, in accordance with a representative embodiment.

FIG. 1B illustrates another network overview for dynamic electronic agreements, in accordance with a representative embodiment.

FIG. 2 illustrates a communication flow for dynamic electronic agreements, in accordance with a representative embodiment.

FIG. 3 illustrates a method for dynamic electronic agreements, in accordance with a representative embodiment.

FIG. 4 illustrates another method for dynamic electronic agreements, in accordance with a representative embodiment.

FIG. 5 illustrates a computer system for dynamic electronic agreements, in accordance with a representative embodiment.

FIG. 6 illustrates another method for dynamic electronic agreements, in accordance with a representative embodiment.

FIG. 7 illustrates another method for dynamic electronic agreements, in accordance with a representative embodiment.

FIG. 8 illustrates another method for dynamic electronic agreements, in accordance with a representative embodiment.

### DETAILED DESCRIPTION

In the following detailed description, for purposes of explanation and not limitation, representative embodiments disclosing specific details are set forth in order to provide a thorough understanding of the representative embodiments according to the present teachings. Descriptions of known systems, devices, materials, methods of operation and methods of manufacture may be omitted so as to avoid obscuring the description of the representative embodiments. Nonetheless, systems, devices, materials, and methods that are within the purview of one of ordinary skill in the art are within the scope of the present teachings and may be used in accordance with the representative embodiments. It is to be understood that the terminology used herein is for purposes of describing particular embodiments only, and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure.

As used in the specification and appended claims, the singular forms of terms ‘a’, ‘an’ and ‘the’ are intended to include both singular and plural forms, unless the context clearly dictates otherwise. Additionally, the terms “comprises”, and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

In view of the foregoing, the present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims

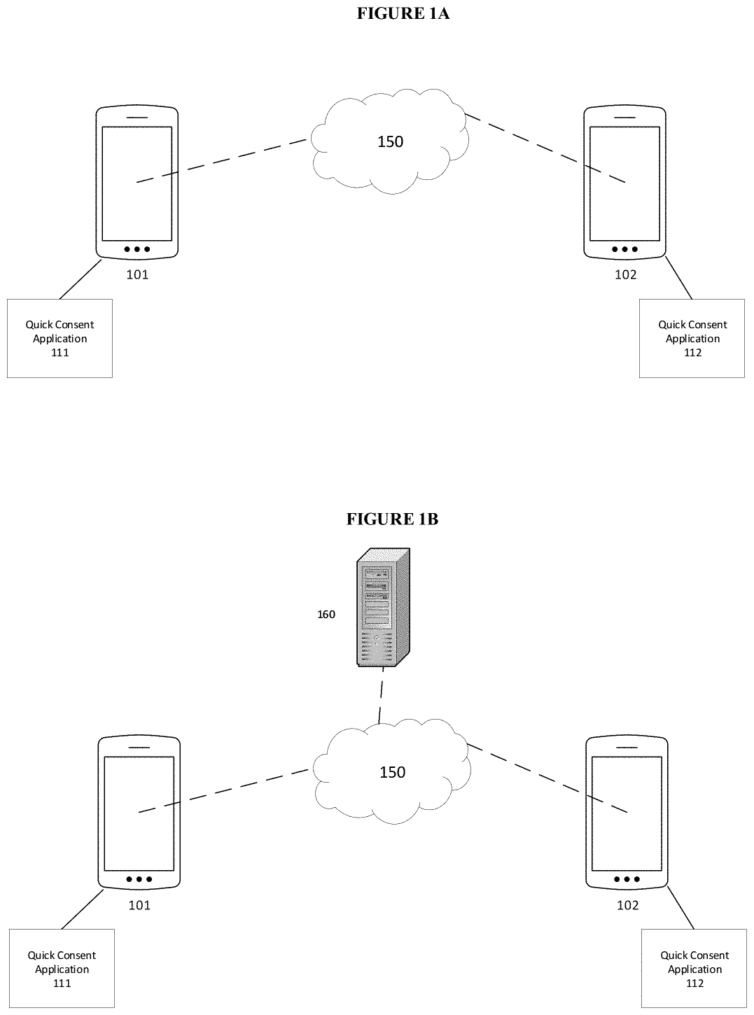

FIG. 1A illustrates a network overview for dynamic electronic agreements, in accordance with a representative embodiment.

In FIG. 1A, a first electronic device 101 communicates with a second electronic device 102 over a communication network 150. The first electronic device 101 is a communication device and the second electronic device 102 is a communication device. The first electronic device 101 has a first quick consent application 111 installed thereon. The second electronic device 102 has a second quick consent application 112 installed thereon. The first quick consent application 111 and the second quick consent application 112 are examples representative of software applications that are specifically designed and configured for use for dynamic electronic agreements as described herein. For example, the first quick consent application 111 and the second quick consent application 112 may be obtained via an online store that verifies and provides access to software applications. The first quick consent application 111 and the second quick consent application 112 may provide rendered user interfaces that interactively change based on selections of users.

The first electronic device 101 and the second electronic device 102 may each be portable electronic devices such as smart phones, tablet computers, laptop computers or other types of mobile electronic devices. Each of the first electronic device 101 and the second electronic device 102 may correspond to one or more permanent dedicated network communication addresses such as telephone numbers and/or temporary dedicated network communication addresses such as internet protocol (IP) addresses. Each of the first electronic device 101 and the second electronic device 102 may also have other executable applications installed thereon/therein, and the executable applications may obtain addressable communication addresses by which a user can communicate when the user logs into the other executable applications. Examples of such other executable applications installed on the first electronic device 101 and/or the second electronic device 102 include email applications, social media applications and/or messaging applications.

The communication network 150 may be implemented by a local area network (LAN) and/or by a wide area network (WAN). The communication network 150 may be implemented by a wireless network and/or a wired network. In the instance of a wireless local area network, the communication network 150 may be implemented by a wireless fidelity (WiFi) network. In the instance of a wireless wide area network, the communication network 150 may be implemented by a data cellular network such as an LTE network or a 5G network.

In some embodiments, the communication network 150 may not be necessary for communications between the first electronic device 101 and the second electronic device 102. For example, the first electronic device 101 and the second electronic device 102 may communicate directly with one another via a Bluetooth protocol or a near field communication (NFC) protocol. The first electronic device 101 and the second electronic device 102 may also communicate directly with one another via a wire such as an Ethernet wire that connects to ports on the first electronic device 101 and the second electronic device 102.

In FIG. 1A, the first electronic device 101 may dynamically provide the second electronic device 102 with access to the second quick consent application 112. For example, the first electronic device 101 may dynamically provide a copy of the first quick consent application 111 as the second quick consent application 112 upon request. Alternatively, the first electronic device 101 may dynamically provide a link to a website or online store from which the second electronic device 102 may retrieve the second quick consent application 112. The link may be provided via an email or a message.

FIG. 1B illustrates another network overview for dynamic electronic agreements, in accordance with a representative embodiment.

In FIG. 1B, the first electronic device 101 again communicates with the second electronic device 102 over the communication network 150. Additionally, the first electronic device 101 again has the first quick consent application 111 installed thereon, and the second electronic device 102 again has the second quick consent application 112 installed thereon.

In FIG. 1B, a server 160 also communicates with the first electronic device 101 and the second electronic device 102 via the communication network 150. The server 160 may dynamically provide the first quick consent application 111 to the first electronic device 101 and/or the second quick consent application 112 to the second electronic device 102. For example, the server 160 may dynamically provide instantiations of the quick consent application upon request.

Although not shown in FIG. 1B, the server 160 may alternatively be used to interact with the first electronic device 101 and the second electronic device 102 in the process of dynamically recording an agreement. Interactive activity that may involve a server 160 and the first electronic device 101 and/or the second electronic device 102 in the process of dynamically recording an agreement is described with respect to one or more of the methods herein.

Although not shown in FIG. 1B, a network for dynamic electronic agreements may include multiple servers including the server 160. For example, the server 160 may be used to dynamically provide the first quick consent application 111 to the first electronic device 101 and the second quick consent application 112 to the second electronic device 102. Another server (not shown in FIG. 1B) may interact with the first quick consent application 111 and the second quick consent application 112 in the process of dynamically recording an agreement. Alternatively, the server 160 may interact with the first quick consent application 111 and the second quick consent application 112 in the process of dynamically recording an agreement, and another server (not shown in FIG. 1B) may be used to dynamically provide the first quick consent application 111 to the first electronic device 101 and the second quick consent application 112 to the second electronic device 102.

An example use of the embodiments in FIG. 1A and FIG. 1B is when a first party with the first electronic device 101 wants to dynamically record an agreement with a second party with the second electronic device 102. The first party may initiate the first quick consent application 111 and the second party may initiate the second quick consent application 112, and the first quick consent application 111 and the second quick consent application 112 may be interactively used as described relative to various embodiments and examples herein.

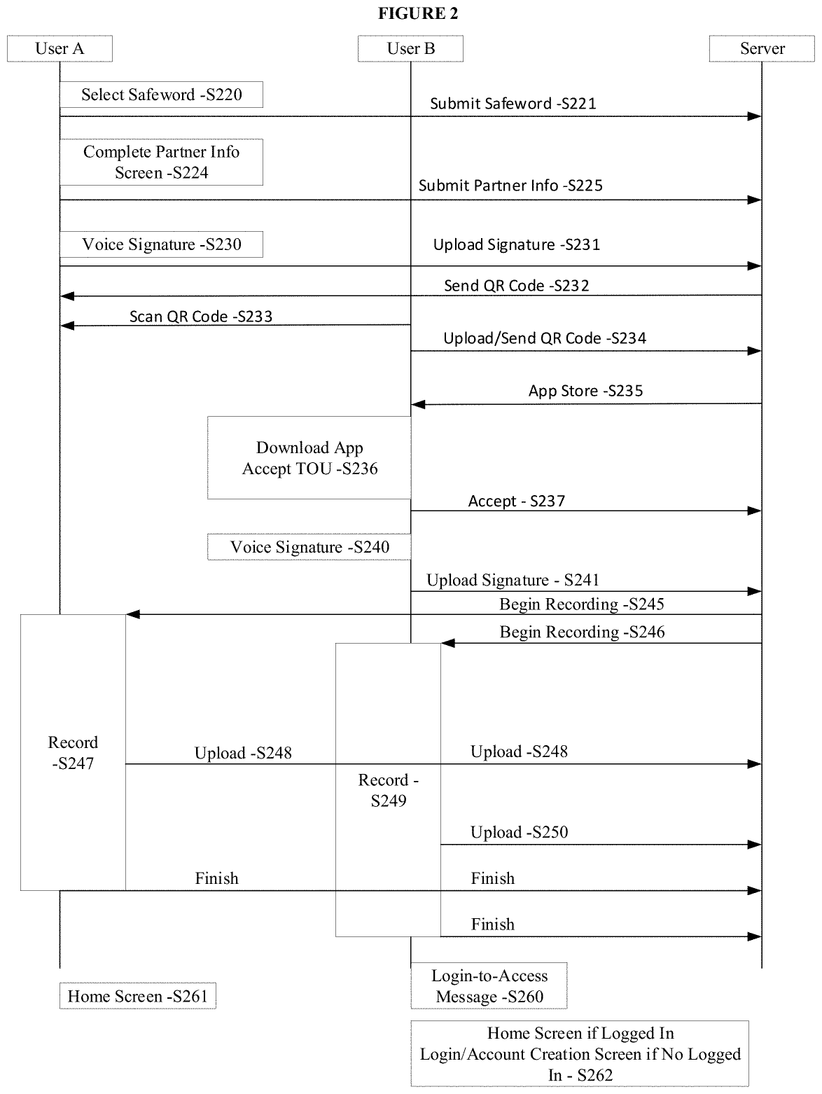

FIG. 2 illustrates a communication flow for dynamic electronic agreements, in accordance with a representative embodiment.

In FIG. 2, user A and user B may each be assumed to have a mobile electronic communication device such as a smartphone. The mobile electronic communication devices used by user A and user B may each have a quick consent application installed thereon. For example, the mobile electronic communication devices may be the first electronic device 101 and the second electronic device 102 from the embodiments in FIG. 1A and FIG. 1B.

At S220, user A selects a safe word and enters the safe word on a first mobile electronic communication device. As examples of how the safe word may be selected, the safe word may be selected from a drop down list, from a set of selectable options each with a corresponding checkbox, may be dynamically set by user A independent of any prompting, or may be selected from automatic suggestions which are automatically filled out as suggestions/prompts as user A speaks or types. At S221, user A submits the safe word to a server. The submission at S221 may be automatic when user A selects the safe word, or may include user A confirming the selection of the selectable option and hitting a separate Send softkey. The server which receives the safe word in FIG. 2 may be the server 160 from the embodiment in FIG. 1B.

At S224, user A completes a partner information screen on the first mobile electronic communication device. The partner information screen may provide fields to enter information for a name and communication address for user B. The communication address for user B may be any form of communication address by which the first mobile electronic communication device may receive a communication, and may include a phone number, an email address, a messaging identity used as a communication address for a social media application, or another form of communication address. At S225, user A submits the partner information to the server. The partner information may be sent to the server when user A hits a Send softkey.

At S230, user A provides a voice signature to the first mobile electronic communication device. The voice signature may be provided via a microphone on the first mobile electronic communication device. For example, user A may hit a Record softkey with a microphone icon in order to activate the microphone and provide the voice signature. Additionally, the voice signature may be prompted from user A by a visual and/or audible prompt from the quick consent application installed on the first mobile electronic communication device. Any prompt for the voice signature may guide user A with words to say, such as their name and a short statement. At S231, user A uploads the voice signature to the server. The voice signature may be uploaded when user A hits a Send softkey.

At S232, the server sends a QR code (a quick response code) to user A. The QR code is a two-dimensional image that may uniquely identify the session between user A and user B, including any agreement reached between user A and user B. While FIGS. 2 and S232 describe use of a QR code as a unique identifier of a session, other forms of unique two-dimensional visualizations which use image data may alternatively be used. For example, a provider of the quick consent applications described herein may create its own set of unique two-dimensional visualizations for use in the manner of QR codes, but which do not necessarily meet any particular definition of QR codes.

The QR code sent at S232 may include a deep link embedded into the two-dimensional image. Most modern mobile electronic communication devices are configured to automatically recognize and read QR codes when the QR codes are scanned by cameras in the modern smartphones. Based on reading the embedded deep link, a mobile electronic communication device may open a browser to check a specific location at a corresponding online application store. According to embodiments based on FIG. 2, the second mobile electronic communication device may visit a Quick Consent application page of the Apple App Store if the second mobile electronic communication device is an IPhone, or a Quick Consent application page of the Google Play Store if the second mobile electronic communication device is an Android device.

At S233, user B scans the QR code on user A's device. If the second mobile electronic communication device already has the quick consent application installed thereon/therein, User B may first open the quick consent application installed on the second mobile electronic communication device, and the quick consent application may automatically open a camera view to scan the QR code based on an instruction from the server when the server sends the QR code to user A at S232. Alternatively, user B may simply open up the camera on the second mobile electronic communication device such as by hitting a soft key for the camera, regardless of whether the quick consent application is already installed on the second mobile electronic communication device. In either case, the second mobile electronic communication device may read and recognize the QR code, open the browser based on reading the embedded deep link, and either open the quick consent application on the second mobile electronic device or visit the online application store corresponding to the type of the second mobile electronic communication device to obtain the quick consent application.

At S234, user B uploads the QR code scanned from user A's device. The QR code may be uploaded automatically upon completion of the scan, or may be uploaded when user B selects an Upload softkey. The embedded deep link in the QR code is read by the second mobile electronic communication device and understood as an instruction to open a quick consent application or to open browser and proceed to the quick consent application page of the appropriate online application store.

If the second mobile electronic communication device used by user B does not have an existing ability to recognize the embedded link in the QR code presented on the first mobile electronic communication device used by user A, user B may be required to download a third-party application to the second mobile electronic communication device. The third-party application may allow the second mobile electronic communication device to read the embedded link and either be directed to the quick consent application on the second mobile electronic communication device or to the online application store native to the second mobile electronic communication device so that user B can download the quick consent application.

At S235, user B is redirected to the appropriate online application store for the second mobile electronic communication device. The online application store will check whether the second mobile electronic communication device already has the quick consent application installed therein and, if so, whether user B has fully registered for services using the quick consent application. If user B is already registered with the server, the process skips S236 and S237 and proceeds to S240.

At S236, user B downloads the quick consent application, assuming the second mobile electronic communication device does not already have the quick consent application installed thereon. The quick consent application page is automatically opened by the browser based on the instruction in the QR code. However, in other embodiments the quick consent application may be downloaded when the quick consent application is automatically entered as a search term for the online application store and user B selects the quick consent application for downloading. In still other embodiments, the quick consent application may be downloaded when user B enters the quick consent application as a search term for the online application store. At S236, user B also accepts the terms of use (TOU) for the quick consent application. At S237, user B sends acceptance of the terms of use for the quick consent application to the server. In other words, when the quick consent application was not previously installed on the second mobile electronic communication device, user B is required to agree to or at least acknowledge the terms of use when the quick consent application is newly installed on the second mobile electronic communication device.

At S240, user B provides a voice signature to the second mobile electronic communication device. The voice signature may be provided via a microphone on the second mobile electronic communication device. For example, user B may hit a Record softkey with a microphone icon in order to activate the microphone and provide the voice signature. Additionally, the voice signature may be prompted from user B by a visual and/or audible prompt from the quick consent application installed on the second mobile electronic communication device. Any prompt for the voice signature may guide user B with words to say, such as their name and a short statement. At S241, user B uploads the voice signature to the server. The voice signature may be uploaded when user B hits a Send softkey.

At S245, the server instructs the first mobile electronic communication device of user A to begin recording. The recording at S245 may begin without any additional confirmation from user A. The server may instruct the first mobile electronic communication device at S245 based on receiving the uploaded voice signature from user B at S241. At S246, the server instructs the second mobile electronic communication device of user B to begin recording. The recording at S246 may begin without any additional confirmation from user B. The server may instruct the second mobile electronic communication device at S246 based on receiving the uploaded voice signature from user B at S241.

At S247, the first mobile electronic communication device begins recording, and at S248 the first mobile electronic communication device uploads the recording to the server. For example, the first mobile electronic communication device may stream the recording from the first mobile electronic communication device to the server. Alternatively, the first mobile electronic communication device may store and encrypt the audio during recording, and transmit a file with the encrypted audio after the recording is completed. The first mobile electronic communication device may also or alternatively store a copy of the recording locally.

At S249, the second mobile electronic communication device begins recording, and at S250 the second mobile electronic communication device uploads the recording to the server. For example, the second mobile electronic communication device may stream the recording from the second mobile electronic communication device to the server. Alternatively, the second mobile electronic communication device may store and encrypt the audio during recording, and transmit a file with the encrypted audio after the recording is completed. The second mobile electronic communication device may also or alternatively store a copy of the recording locally.

After S248 and S249, the recordings are finished. The recordings may be finished at S248 and S249 when user A and user B manually stop the recordings, when the first mobile electronic communication device and the second mobile electronic communication device move away from each other such as by a predetermined distance, or based on user A and user B each speaking a predetermined trigger word used to confirm that recording should be stopped. User A and user B may have different predetermined trigger words, and the predetermined trigger words may be set in advance of any particular session by user A and/or user B.

At S260, the second mobile electronic communication device of user B is provided with a login-to-access message via the quick consent application. The login-to-access message may allow user B to login to the quick consent application in order to retrieve and review the recording made by user B. The login-to-access message may be provided immediately after the recordings are finished, or may be provided a set period afterwards such as six or eight or ten hours afterwards. When user B logs in, user B may be required to accept terms of use before being provided access to the audio recording recorded by the second mobile electronic communication device of user B, if such acceptance was not previously provided.

User A is also provided with the ability to obtain any audio recording recorded by the first mobile electronic communication device of user A. For example, if a dispute raises questions as to the consent in the agreement between user A and user B, user A may log in and retrieve the audio streamed from the first mobile electronic communication device of user A.

At S261, the first mobile electronic communication device of user A returns to a home screen. The first mobile electronic communication device may return to the home screen immediately after recording is stopped, or after a predetermined period such as 5 minutes.

At S262, if user B logs in at S260, the second mobile electronic communication device of user B returns to a home screen. If user B does not log in at S260, at S262 the second mobile electronic communication device of user B returns to an account creation screen.

In the description of FIG. 2 above, the process for user B depends on whether the second mobile electronic communication device has the quick consent application installed thereon and whether user B has agreed to the terms of use or even fully registered for the quick consent service. However, user B may be allowed to use the quick consent application multiple times without fully registering for the quick consent application, such as by never requesting to review the recording of a previous session by the quick consent service. In some embodiments, user B may be requested to provide additional partial information subsequent to the first unregistered use of the quick consent application, such as by providing a birthdate the second time the quick consent application is used without registering, and by providing the last four digits of a social security number the third time the second time the quick consent application is used without registering.

Additionally, when user A and user B each have the quick consent application installed on their mobile electronic communication devices, the process of FIG. 2 may be modified so that the online application stores are not involved. Rather, if user A completes the partner information screen at S224 and the partner information corresponds to a recognized user B, a server such as the server 160 in FIG. 1B may instruct the second mobile electronic communication device to open up the quick consent application for scanning the QR code at S233, and may subsequently skip to S237 and S240.

Additionally, although not shown in FIG. 1A or FIG. 1B, modular memory elements may be used to store electronic identification for users such as user A and user B. The modular memory elements may be adapted to plug into particular types of mobile electronic communication devices such as the first electronic device 101 and the second mobile electronic communication device, and may automatically trigger execution of a program such as the quick consent application or an interface that allows users to select from a set of applications including the quick consent application. In this way, electronic communication devices may quickly initiate dynamic electronic agreements when users plug their modular memory elements into the electronic communication devices to trigger activation of the quick consent application, or an interface that allows users to select the quick consent application.

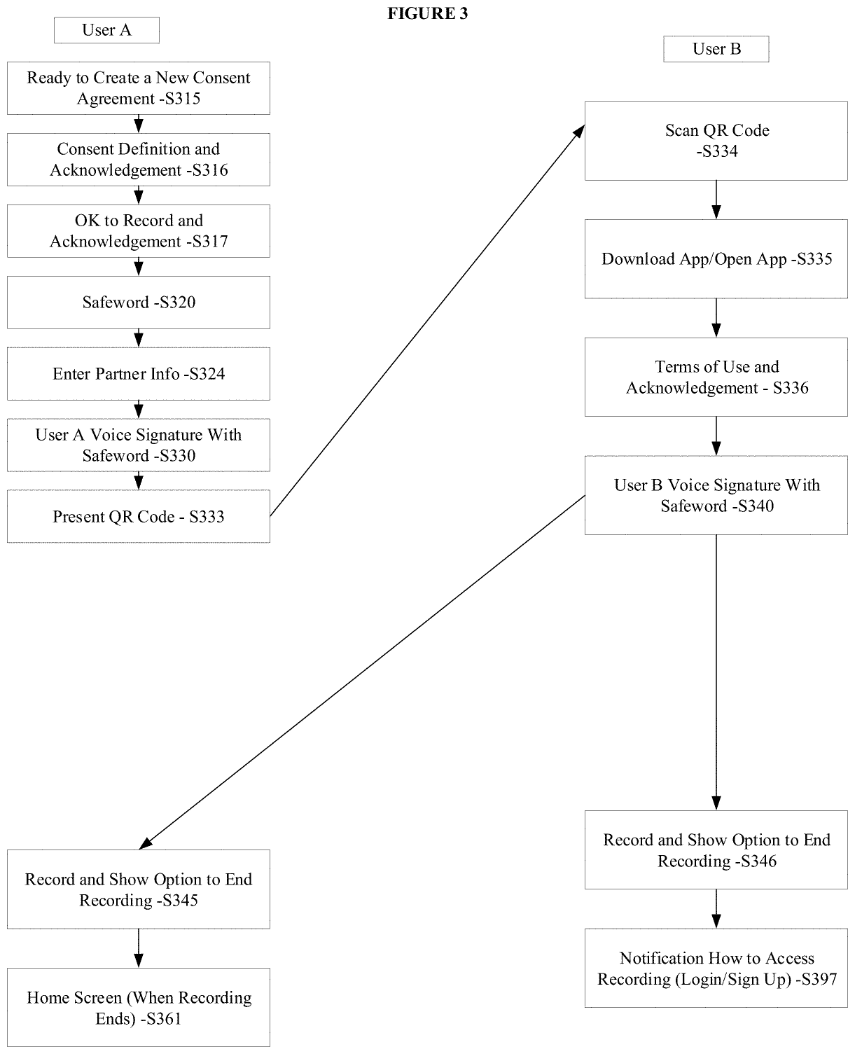

FIG. 3 illustrates a method for dynamic electronic agreements, in accordance with a representative embodiment.

The method of FIG. 3 starts with user A at S315. At S315, the first mobile electronic communication device of user A is ready to create a new quick consent agreement. User A may open up a quick consent application installed on a first mobile electronic communication device used by user A.

At S316, user A is provided with a consent definition and acknowledgement, confirming that user A understands what is meant by the term “consent”. User A may acknowledge understanding by hitting an Accept softkey or another similar form of acknowledgement.

At S317, user A provides authorization to record. User A may provide authorization to record by hitting a Record softkey with an icon of a microphone.

At S320, user A enters a safe word. The safe word is entered via user A selecting the safe word from a drop down box, by checking a soft checkmark next to the safe word on a list of safe words displayed on a screen of the first mobile electronic communication device, or in any of the other manners described herein. The first mobile electronic communication device may transmit the safe word from user A to the server.

At S324, user A enters the partner information for user B, including at least a communication address for user B. The communication address may be a telephone number, an email address, or a user identification associated with an application already installed on the second mobile electronic communication device used by user B.

At S330, user A provides a voice signature with the safe word entered at S320.

At S333, the server sends a QR code to user A. The QR code includes a deep link embedded therein.

At S334, user B scans the QR code on the first mobile electronic communication device. The second mobile electronic communication device used by user B may automatically recognize the QR code and the deep link, open a browser and visit the quick consent application page at the corresponding online application store. In some embodiments, instead of visiting the quick consent application page, when the server recognizes the communication address for user B, the second mobile electronic communication device may visit or at least communicate with a quick consent website at the server 160 in FIG. 1B, and skip S335 and S336 which are described below.

If the second mobile electronic communication device used by user B does not have an existing ability to recognize the embedded link in the QR code presented on the first mobile electronic communication device used by user A, user B may be required to download a third-party application. The third-party application may allow the second mobile electronic communication device to read the embedded link and either be directed to the quick consent application on the second mobile electronic communication device or to the online application store native to the second mobile electronic communication device so that user B can download the quick consent application.

At S335, assuming that the second mobile electronic communication device does not already have the quick consent application installed thereon, user B downloads the quick consent application to the second mobile electronic communication device and opens the quick consent application.

At S336, user B accepts or at least acknowledges the terms of use for the quick consent application.

At 5340, user B provides a voice signature with the safe word to the second mobile electronic communication device. The voice signature with the safe word from user B is transmitted to the server.

At 5345, the first mobile electronic communication device begins recording, and provides an option to end the recording. The recording from the first mobile electronic communication device is streamed to the server and may also be stored on the first mobile electronic communication device.

At 5346, the second mobile electronic communication device begins recording, and provides an option to end the recording. The recording from the second mobile electronic communication device is streamed to the server and may also be stored on the second mobile electronic communication device.

As an alternative to streaming at S345 and S346, the quick consent application may record a session in full on an electronic communication device, encrypt the file, and then upload the encrypted file to a central server before the file is deleted from the electronic communication device.

At S360, after the recording on the second mobile electronic communication device ends, user B is presented with a notification of how to access the recording(s) via a login page or a sign-up page and then a login page.

At S361, user A is presented with the home screen after the recording on the first mobile electronic communication device ends.

In the embodiments of FIG. 2 and FIG. 3, an unregistered user B may still use the quick consent application even multiple times. For example, after first initially acknowledging the terms of user at S336 in a first use of the quick consent application in FIG. 3, user B may return and enter a first name, last name, and password and be allowed to proceed to the voice signature page. User B may have been required to provide the first name, last name, and password in the first use, but subsequent use is allowed even when user B has not fully registered with the quick consent application. Otherwise, after any unregistered use, user B may fully register with the quick consent application. Full registration may include performance of a background check, and obtaining additional information from user B such as a birthday, social security number, street address and so on. In some embodiments, user B may be prompted to provide additional information in subsequent uses, even if user B is not fully registering with the quick consent service.

Additionally, in some embodiments based on FIG. 2 and FIG. 3, a fully-registered user B may be recognized so that a process for user B starts at S240 or S340. Registered users may also have identification data stored separately from their electronic communication devices, such as on a memory card or a portable memory that interfaces with electronic communication devices via ports. Using such separate memory systems, users may even use the same electronic communication device to engage with a system that implements dynamic electronic agreements, though in this instance any recording should be streamed to the server 160 or another central component or sent immediately after recording so as not to be solely under the control of one party to a dynamic electronic agreement. Nevertheless, in some embodiments, identification management may be leveraged so that user A and user B both use the same electronic communication device such as the first mobile electronic device 101 or the second electronic device 102. Additionally, in some embodiments, the identification management involving a separate memory system may use near field communications (NFC) so that the separate memory system does not have to plug into the electronic communication device, and may instead simply identify user B and/or user A by placing the separate memory system near to the electronic communication devices.

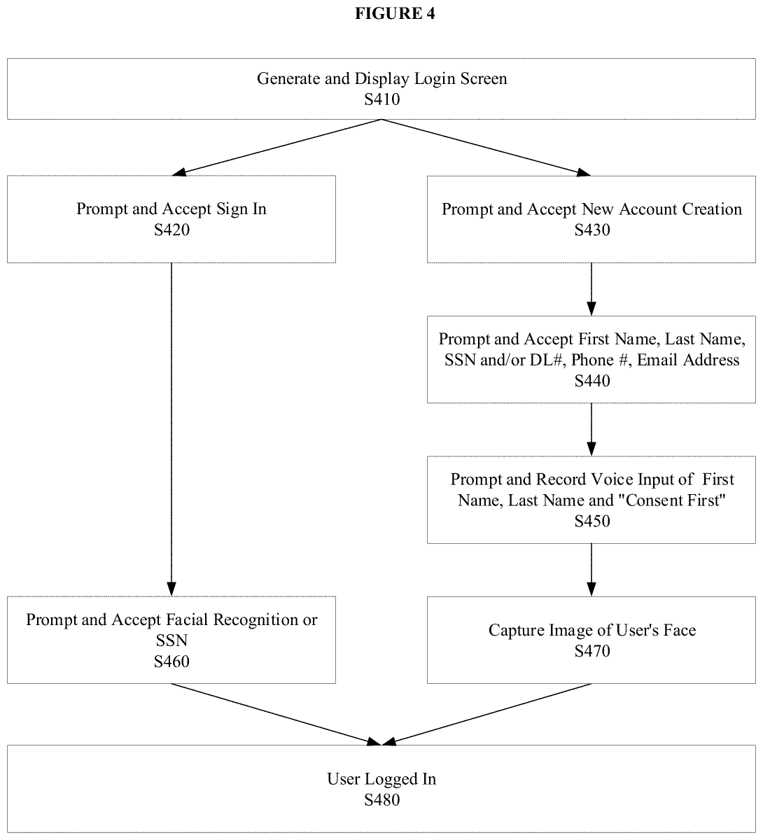

FIG. 4 illustrates another method for dynamic electronic agreements, in accordance with a representative embodiment.

The method of FIG. 4 provides a mechanism for installing a quick consent application on the first electronic device 101 and/or the second electronic device 102. The method starts at S410 by generating and displaying a login screen which is a default start screen for the quick consent application. The login screen may be generated and displayed in response to entering a uniform resource locater (URL) address in an address bar of a browser, or in response to clicking a link in, for example, an email or message so as to automatically populate the URL address in the browser. The login screen may be a web page or, alternatively, may be the default start screen of the downloaded quick consent application once the quick consent application is downloaded into/onto the first electronic device 101 and/or the second electronic device 102.

At S420, the method includes prompting and accepting a sign in. S420 presumes that a user has an existing account for the quick consent application. For example, the login screen for the quick consent application may provide prompts to sign in or to create a new account. The sign in process may accept a username such as an email address along with a password. The prompting at S420 may be via an application installed on the first electronic device 101, and is to initiate coordination between the first electronic device 101 and the second electronic device 102 via the application. Although S420 and most teachings herein use the example of two communication devices being coordinated, the present description is not limited to two communication devices and more than two communication devices may be coordinated using the teachings herein.

As S460, the method includes prompting and accepting facial recognition or a social security number as a secondary confirmation of identity of the user. Other forms of secondary confirmation of identity may also or alternatively be prompted and accepted at S460, including fingerprint(s) or voice sample(s). S460 follows S420, and is based on the assumption that the user has an existing account and has previously supplied a facial image, the social security number, and/or other forms of secondary confirmation of identity.

At S480, the method includes logging the user into the quick consent application after confirming the secondary identification accepted at S460. For the purposes of logging into the quick consent application, the method of FIG. 4 ends after logging in at S480.

If the user does not have an existing account, the user is prompted from the home screen to accept an option to create a new account at S430. Clicking a link for creating a new account may result in a display of a secondary page for account creation. A user may be provided with an ability to quickly create a new account, such as by paying for an external service that can verify sensitive information for a queried individual. The user may provide the sensitive information when the user creates the new account, and the sensitive information can be quickly verified by the external service. As a result, the user may be quickly enabled to participate in dynamic electronic agreements after first creating a profile, though, as described herein, other verifications are provided in order to record the user's willingness to engage in each specific agreement.

At S440, the method of FIG. 4 includes prompting and accepting the user's first name, last name, social security number (SSN) and/or driver's license number (DL#), along with phone number and email address. Other forms of user information may also be prompted and accepted at S440.

At S450, the method of FIG. 4 includes prompting and recording voice input of the user's first name, last name and “Quick Consent”. The voice input may be used as a secondary confirmation of identity when the user logs in later, such as in S460 described previously. The capturing of the voice input at S450 includes the quick consent application taking control of the microphone functions on the portable electronic device used to sign in, capturing and confirming the voice input, and storing the captured voice input in a memory accessible to the quick consent application.

At S470, the method of FIG. 4 includes capturing an image of the user's face. The image captured at S470 may also be used as a secondary confirmation of identity when the user logs in later, such as in S460 described previously. The capturing of the image at S470 includes the quick consent application taking control of the camera functions on the portable electronic device used to sign in, capturing and confirming the image of the user's face, and storing the captured image in a memory accessible to the quick consent application.

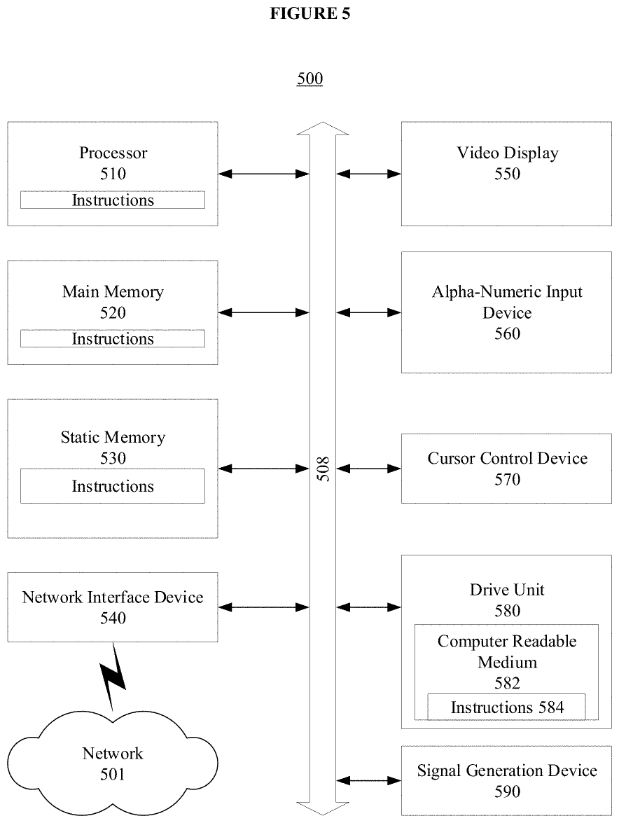

FIG. 5 illustrates a computer system for dynamic electronic agreements, in accordance with a representative embodiment.

FIG. 5 illustrates a computer system, on which a method for dynamic electronic agreements is implemented, in accordance with another representative embodiment.

The computer system 500 of FIG. 5 shows a complete set of components for a communication device or a computer device. However, a “controller” which implements some or all aspects of methods performed by the first electronic device 101, the second electronic device 102 or the server 160 may be implemented with less than the set of components of FIG. 5, such as by a memory and processor combination. The computer system 500 may include some or all elements of one or more component apparatuses in a system for dynamic electronic agreements herein, although any such apparatus does not necessarily require one or more of the elements described for the computer system 500 and may include other elements not described.

Referring to FIG. 5, the computer system 500 includes a set of software instructions that can be executed to cause the computer system 500 to perform any of the methods or computer-based functions disclosed herein. The computer system 500 may operate as a standalone device or may be connected, for example, using a network 501, to other computer systems or peripheral devices. In embodiments, a computer system 500 performs logical processing based on digital signals received via an analog-to-digital converter.

In a networked deployment, the computer system 500 operates in the capacity of a server or as a client user computer in a server-client user network environment, or as a peer computer system in a peer-to-peer (or distributed) network environment. The computer system 500 can also be implemented as or incorporated into various devices, such as the first electronic device 101, the second electronic device 102, the server 160, a stationary computer, a mobile computer, a personal computer (PC), a laptop computer, a tablet computer, or any other machine capable of executing a set of software instructions (sequential or otherwise) that specify actions to be taken by that machine. The computer system 500 can be incorporated as or in a device that in turn is in an integrated system that includes additional devices. In an embodiment, the computer system 500 can be implemented using electronic devices that provide voice, video, or data communication. Further, while the computer system 500 is illustrated in the singular, the term “system” shall also be taken to include any collection of systems or sub-systems that individually or jointly execute a set, or multiple sets, of software instructions to perform one or more computer functions.

As illustrated in FIG. 5, the computer system 500 includes a processor 510. The processor 510 executes instructions to implement some or all aspects of methods and processes described herein. The processor 510 is tangible and non-transitory. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor 510 is an article of manufacture and/or a machine component. The processor 510 is configured to execute software instructions to perform functions as described in the various embodiments herein. The processor 510 may be a general-purpose processor or may be part of an application specific integrated circuit (ASIC). The processor 510 may also be a microprocessor, a microcomputer, a processor chip, a controller, a microcontroller, a digital signal processor (DSP), a state machine, or a programmable logic device. The processor 510 may also be a logical circuit, including a programmable gate array (PGA), such as a field programmable gate array (FPGA), or another type of circuit that includes discrete gate and/or transistor logic. The processor 510 may be a central processing unit (CPU), a graphics processing unit (GPU), or both. Additionally, any processor described herein may include multiple processors, parallel processors, or both. Multiple processors may be included in, or coupled to, a single device or multiple devices.

The term “processor” as used herein encompasses an electronic component able to execute a program or machine executable instruction. References to a computing device comprising “a processor” should be interpreted to include more than one processor or processing core, as in a multi-core processor. A processor may also refer to a collection of processors within a single computer system or distributed among multiple computer systems. The term computing device should also be interpreted to include a collection or network of computing devices each including a processor or processors. Programs have software instructions performed by one or multiple processors that may be within the same computing device or which may be distributed across multiple computing devices.

The computer system 500 further includes a main memory 520 and a static memory 530, where memories in the computer system 500 communicate with each other and the processor 510 via a bus 508. Either or both of the main memory 520 and the static memory 530 may be considered representative examples of the memory 1222 of the controller 122 in FIG. 1B, and store instructions used to implement some or all aspects of methods and processes described herein. Memories described herein are tangible storage mediums for storing data and executable software instructions and are non-transitory during the time software instructions are installed therein/thereon. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The main memory 520 and the static memory 530 are articles of manufacture and/or machine components. The main memory 520 and the static memory 530 are computer-readable mediums from which data and executable software instructions can be read by a computer (e.g., the processor 510). Each of the main memory 520 and the static memory 530 may be implemented as one or more of random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. The memories may be volatile or non-volatile, secure and/or encrypted, unsecure and/or unencrypted.

“Memory” is an example of a computer-readable storage medium. Computer memory is any memory which is directly accessible to a processor. Examples of computer memory include, but are not limited to RAM memory, registers, and register files. References to “computer memory” or “memory” should be interpreted as possibly being multiple memories. The memory may for instance be multiple memories within the same computer system. The memory may also be multiple memories distributed amongst multiple computer systems or computing devices.

As shown, the computer system 500 further includes a video display unit 550, such as a liquid crystal display (LCD), an organic light emitting diode (OLED), a flat panel display, a solid-state display, or a cathode ray tube (CRT), for example. Additionally, the computer system 500 includes an input device 560, such as a keyboard/virtual keyboard or touch-sensitive input screen or speech input with speech recognition, and a cursor control device 570, such as a mouse or touch-sensitive input screen or pad. The computer system 500 also optionally includes a disk drive unit 580, a signal generation device 590, such as a speaker or remote control, and/or a network interface device 540.

In an embodiment, as depicted in FIG. 5, the disk drive unit 580 includes a computer-readable medium 582 in which one or more sets of software instructions 584 (software) are embedded. The sets of software instructions 584 are read from the computer-readable medium 582 to be executed by the processor 510. Further, the software instructions 584, when executed by the processor 510, perform one or more steps of the methods and processes as described herein. In an embodiment, the software instructions 584 reside all or in part within the main memory 520, the static memory 530 and/or the processor 510 during execution by the computer system 500. Further, the computer-readable medium 582 may include software instructions 584 or receive and execute software instructions 584 responsive to a propagated signal, so that a device connected to a network 501 communicates voice, video, or data over the network 501. The software instructions 584 may be transmitted or received over the network 501 via the network interface device 540.

In an embodiment, dedicated hardware implementations, such as application-specific integrated circuits (ASICs), field programmable gate arrays (FPGAs), programmable logic arrays and other hardware components, are constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, some or all aspects of methods described herein may be implemented using one or more hardware computer system(s) that execute(s) software programs. Further, in an exemplary, non-limited embodiment, implementations can include distributed processing, component/object distributed processing, and parallel processing. Virtual computer system processing may implement one or more of the methods or functionalities as described herein, and a processor described herein may be used to support a virtual processing environment.

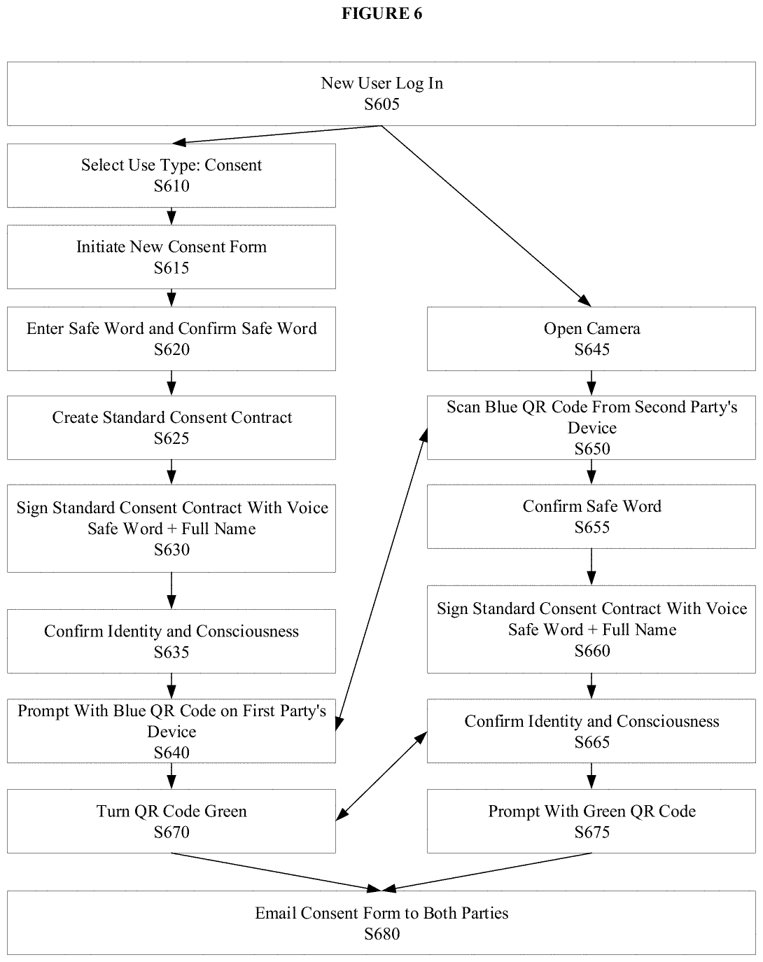

FIG. 6 illustrates another method for dynamic electronic agreements, in accordance with a representative embodiment.

The method of FIG. 6 involves a usage of the quick consent application to memorialize an agreement between the user of the first electronic device 101 and the user of the second electronic device 102.

The method of FIG. 6 starts with the user newly logging in at S605. The user may newly log in by providing the information described above with respect to FIG. 4.

In FIG. 6, two columns of steps are shown, one on the left following S605 is for a first user using the first electronic device 101, and one on the right following S605 is for a second user using the second electronic device 102.

At S610, the method of FIG. 6 includes selecting a use type: consent. The use type: consent that is selected at S610 may be one of multiple types of agreement templates that can be selected via the quick consent application. The consent use type selection may result in a template for a contractual agreement that memorializes consent by one or both parties for a specified activity. The specified activity may be a dangerous activity such as skydiving or underwater diving, or any other type of activity for which consent may be sought from a party.

At S615, a new consent form is initiated. The new consent form may be dynamically generated based on information of the first user known by the first quick consent application 311. The new consent form may also include empty fields which can be populated with information saved with the new consent form in order to dynamically create a unique consent form specific to the details of the agreement being memorialized.

At S620, the user of the first electronic device 101 enters a safe word and confirms the safe word. The safe word may be a unique word dynamically provided by the user of the first electronic device 101 or may be a unique word previously established and newly repeated by the user of the first electronic device 101.

At S625, the method of FIG. 6 includes creating a standard consent contract. The standard consent contract may include predetermined terms and passaged along with information specific to the users using the first electronic device 101 and the second electronic device 102. The standard consent contract may be different from other forms of contracts generated based on predetermined templates.

At S630, the method of FIG. 6 includes signing the standard consent contract with a voiced safe word and full name of the first user in the voice of the first user. The voice file can be captured by the microphone on the first electronic device 101, timestamped and stored with the standard consent contract.

At S635, the method of FIG. 6 includes confirming identity and consciousness of the user using the first electronic device 101. S635 may include prompting and accepting answers to secret questions from the user to confirm the identity of the user. S635 may also include prompting and accepting answers from the user to state whether they have recently consumed intoxicants, to state an answer to a riddle, to repeat a phrase that may easily reflect slurring by a an intoxicated pattern, and other mechanisms to confirm consciousness of the user as well as sobriety.

At S640, the method of FIG. 6 includes prompting the user of the first electronic device 101 with a blue QR code on the first electronic device 101. The blue QR code will be used by the user using the second electronic device 102 to confirm the standard consent contract, as explained below.

After the user of the second electronic device 102 confirms the standard consent contract following S640, the method of FIG. 6 includes turning the QR code on the first communication device green at S670. Afterwards, the finalized consent form is emailed to the user of the first electronic device 101 and the user of the second electronic device 102 at S680.

At S645, the method of FIG. 6 includes opening a camera on the second electronic device 102 after the user of the second electronic device 102 logs in at S605. At S650, the camera on the second electronic device 102 is used to scan the blue QR code on the first electronic device 101.

At S655, the user of the second electronic device 102 confirms to the second electronic device 102 the safe word provided by the user of the first electronic device 101 at S620.

At S660, the method of FIG. 6 includes signing the standard consent contract with the voiced safe word and full name of the user of the second electronic device 102. The voice file can be captured by the microphone on the second electronic device 102, timestamped and stored with the standard consent contract.

At S665, the method of FIG. 6 includes confirming identity and consciousness of the user using the second electronic device 102. S665 may include prompting and accepting answers to secret questions from the user to confirm the identity of the user. S665 may also include prompting and accepting answers from the user to state whether they have recently consumed intoxicants, to state an answer to a riddle, to repeat a phrase that may easily reflect slurring by a an intoxicated pattern, and other mechanisms to confirm consciousness of the user as well as sobriety.

At S675, the user of the second electronic device 102 is prompted with the green QR code on the second electronic device 102. Afterwards, the finalized consent form is emailed to the user of the second electronic device 102 and the user of the first electronic device 101 at S680.

As described above for embodiments based on FIG. 6, a quick consent application may provide several options for different types of agreements that can be selected by users. Dynamic electronic agreements may be used to memorialize many different types of agreements, and is not limited to only one or a few types of agreements.

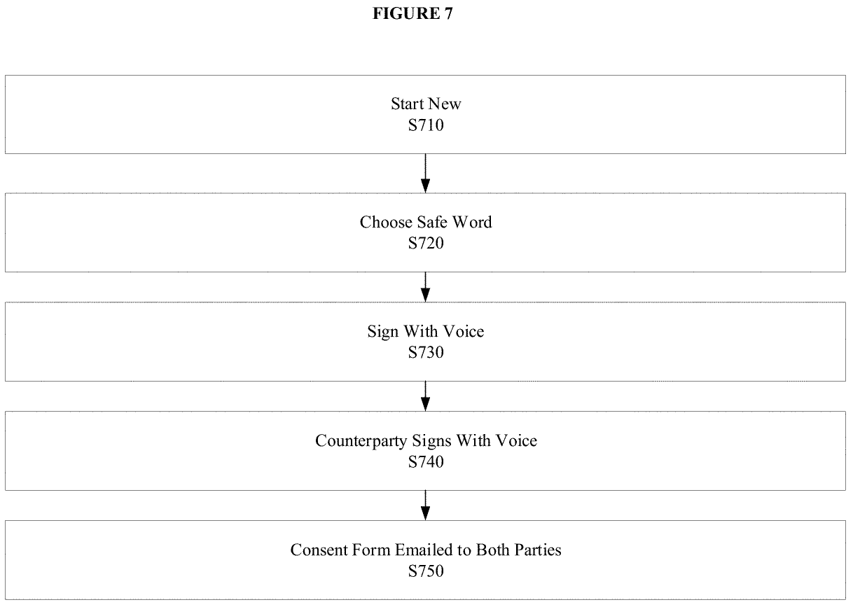

FIG. 7 illustrates another method for dynamic electronic agreements, in accordance with a representative embodiment.

At S710, the method of FIG. 7 includes starting a new quick consent contract.

At S720, the method of FIG. 7 includes choosing a safe word. The safe word may be a word dynamically determined by a user, or dynamically generated by one of the first electronic device 101 or the second electronic device 102.

At S730, the method of FIG. 7 includes signing the new quick consent contract with the safe word by the voice of the user of the first electronic device 101. The quick consent application on the first electronic device 101 may temporarily take control of a microphone on the first electronic device 101 in order to capture the safe word after the user is prompted to speak the safe word.

At S740, the method of FIG. 7 includes signing the new quick consent contract with the safe word by the voice of the user of the second electronic device 102. The quick consent application on the second electronic device 102 may temporarily take control of a microphone n the second electronic device 102 in order to capture the safe word after the user is prompted to speak the safe word.

At S750, the method of FIG. 7 includes emailing the signed consent form to both of the user of the first electronic device 101 and the user of the second electronic device 102 to record the agreement. The signed consent form may also be stored in the server 160 as a verification copy of the signed consent form maintained by the provider of dynamic electronic agreements.

Although embodiments described herein primarily describe technological mechanisms for synchronizing agreements between two parties using two user devices, the dynamic electronic agreements mechanisms described herein are equally applicable for agreements involving more than two parties using more than two user devices. Additionally, agreements may be formed and verified by users who are proxies for underlying parties represented for the agreements.

As an example, in the age of coronavirus-19, a set of parents may agree to form a “pod” for their children who are assigned to a classroom in common. The parents may wish to execute an agreement indicating that the children will not be physically exposed to people outside of a circle of friends, family members, medical care providers, and teachers. Even if the agreement is not legally enforceable, a dynamic electronic agreement signed by parents of each of four or five children in a “pod” may provide reassurance that the children will be safe in the care of others during an epidemic.

In the example of more than two people being party to a dynamic electronic agreement, one party may serve as the first party for a set of second parties so as to individually have each of the second parties participate in a process as described herein. Alternatively, once any party is “in” a dynamic electronic agreement, the dynamic electronic agreement may allow that party to enroll additional persons to the dynamic electronic agreement. For example, a dynamic electronic agreement may specify when written which other parties are expected to sign the dynamic electronic agreement, or a dynamic electronic agreement may be open to accepting new parties even after the dynamic electronic agreement is signed by the first two parties to the dynamic electronic agreement.

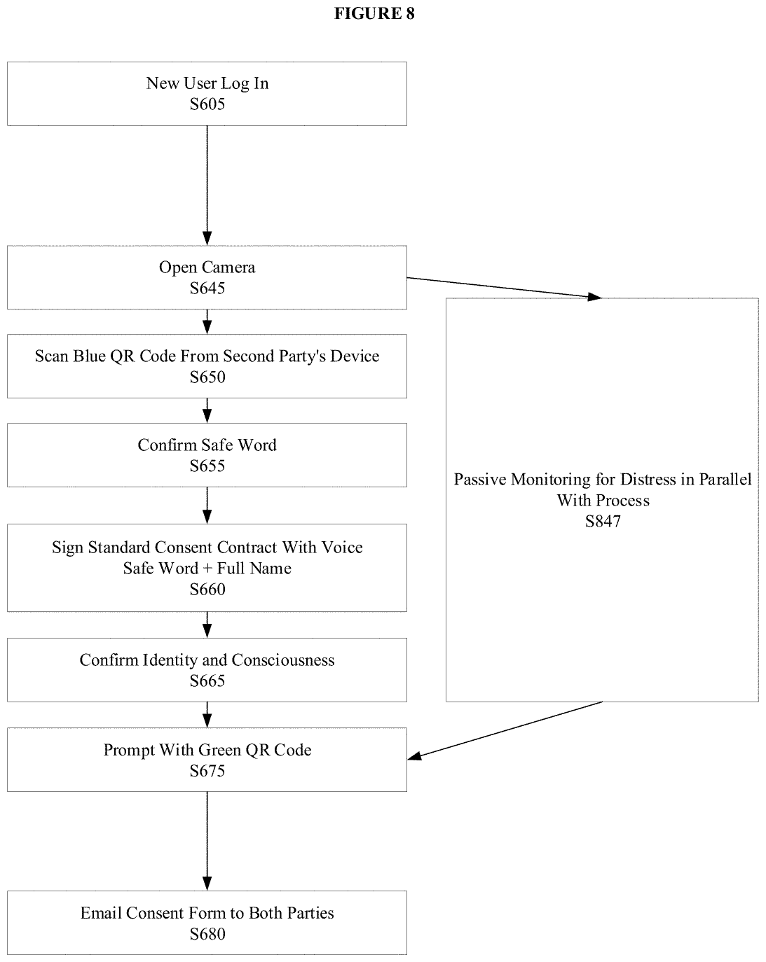

FIG. 8 illustrates another method for dynamic electronic agreements, in accordance with a representative embodiment.

The method of FIG. 8 is similar to the method of FIG. 6. However, in the method of FIG. 8, the second electronic device 102 and/or the first electronic device 101 may passively monitor for distress in parallel with the other functions of the process of FIG. 6. For example, a microphone on the second electronic device 102 may passively monitor for predetermined distress words, or signs of stress such as crying, screaming, whimpering, words such as “no, no, no” and so on. The passive monitoring at S847 may trigger recording of the content captured by the microphone on the second electronic device 102, and/or may be used to trigger a call or message to an operator of the entity that provides the quick consent application so that the operator can determine whether to contact a law enforcement agency and/or an ambulance service to send help.

In an embodiment based on FIG. 8, either or both of the first electronic device 101 and the second electronic device 102 may continuously record audio signals received after a dynamic electronic agreement is first reached or immediately following the first electronic device 101 creating the contract or signing the contract. For example, the first electronic device 101 and/or the second electronic device 102 may record received audio signals for a fixed period of time such as 10 minutes, for a length of time until instructions are received to stop recording (e.g., by use of a predetermined password such as a predetermined password), or until detecting that the first electronic device 101 and the second electronic device 102 have moved apart by a predetermined distance such as 250 feet. The recorded audio may be stored on whichever of the first electronic device 101 and the second electronic device 102 has recorded the audio. In an embodiment, the recorded audio may be provided over a network to a server for storage, either in real-time, with a delay, or after the first electronic device 101 and the second electronic device 102 have moved apart by a predetermined distance such as 250 feet. In an embodiment, users of the first electronic device 101 and the second electronic device 102 may be provided an option to transfer and permanently save a recording, such as within 24 hours of the dynamic electronic agreement being first reached. In an embodiment, the recording may be deleted from the first electronic device 101 and the second electronic device 102 after a predetermined period such as 24 hours if the respective users do not elect to transfer and permanently save the recording.

In another embodiment based on FIG. 8, either or both of the first electronic device 101 and the second electronic device 102 may continuously record audio signals received after a dynamic electronic agreement is first reached but may delete the recorded audio signals in a loop such as after a delay of 3 seconds, 5 second or 30 seconds. The deletion of recorded audio signals may be stopped if a codeword is received indicating that consent has been revoked.

In another embodiment based on FIG. 8, audio may be dynamically recorded in a short loop unless a trigger is detected to record the entire audio signal. Detection of a trigger may also be used to initiate transfer of the audio over a network to a server, either in real-time or immediately after detecting that the first electronic device 101 and the second electronic device 102 have moved apart by a predetermined minimum distance. When audio is sent over a network for storage based on a trigger, the audio may be stored for a period of time such as 30 days or 60 days. The users may be prompted to pay for further storage of the audio or else allow the audio to be delete after the period of time.

In some embodiments, as an alternative or as a supplement to a proximity trigger using predetermined minimum distances, the applications on the first electronic device 101 and the second communication device may prompt with a Stop softkey to end the recording. As another alternative or supplement, the recording may automatically end and the recording may be saved locally when the applications are closed/exited on the first electronic device 101 and/or the second electronic device 102. The applications may take control of the first electronic device 101 and/or the second electronic device 102 to prevent the applications from being closed or exited once a trigger is detected. The control of the first electronic device 101 and/or the second electronic device 102 may prevent an attempt to stop the triggered recording, and/or may stop a loop that deletes passive recording after a predetermined time.

In additional embodiments that are alternative or supplemental to those described above, the application on the first electronic device 101 and/or the second electronic device 102 may freeze so as to prevent a user from closing/exiting the applications until the Stop softkey to stop recording is pressed. In some embodiments, the saved audio may be stored locally and/or centrally for a predetermined minimum amount of time before being deleted, either automatically or at the instruction of the users. In some embodiments, when the Stop softkey to stop the recording is pressed the user will be prompted to input a predetermined password. The input of the predetermined password may be recognized as a type of distress signal and can trigger the audio to be saved locally as well as initiate a transfer of the recorded audio over a network to a server, either in real-time or immediately after detecting the distress signal.

As described above, dynamic electronic agreements can involve automated and non-automated interaction between the first electronic device 101, the second electronic device 102, and the server 160 in order to dynamically memorialize a unique agreement between the user of the first electronic device 101 and the user of the second electronic device 102.

Dynamic electronic agreements is not limited to the details of embodiments described above. For example, contracts that are dynamically generated and memorialized using the teachings herein may be sale contracts such as sales at a garage sale or service contracts such as services provided at a shop such as an auto repair shop. Numerous different contract templates may be provided via quick consent applications, so that parties may memorialize any type of contract in a way that cannot be repudiated later.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

We claim:

1. A method for dynamically recording an agreement, comprising:
receiving, from a first electronic communication device, a safe word;
receiving, from the first electronic communication device, a voice signature from a user of the first electronic communication device;
sending, to the first electronic communication device, a unique code to display on the first electronic communication device;
receiving, from a second electronic communication device, a scan of the unique code on the first electronic communication device;
receiving, from the second electronic communication device, a voice signature from a user of the second electronic communication device;
initiating audio recording on at least one of the first electronic communication device and the second electronic communication device, and receiving recorded audio of the audio recording;
storing the recorded audio at a central system, and
providing access to the recorded audio.

2. The method of claim 1, further comprising:
receiving, from the first electronic communication device, information of a user of the second electronic communication device before receiving the voice signature from the user of the first electronic communication device.

3. The method of claim 1, wherein the unique code comprises a quick response code, wherein the quick response code comprises a deep link to an interne protocol address embedded therein.

4. The method of claim 1, wherein the scan of the unique code is captured by a camera on the second electronic communication device.

5. The method of claim 1, wherein the unique code automatically directs the second electronic communication device to an online application store.

6. The method of claim 1, further comprising:
receiving acceptance of terms of use from the second electronic communication device, and prompting the second electronic communication device for the voice signature based on receiving acceptance of the terms of use.

7. The method of claim 1, wherein the audio recording is streamed from the at least one of the first electronic communication device and the second electronic communication device until the recording is finished.

8. The method of claim 1, further comprising:
stopping the audio recording based on receiving a first predetermined trigger word from a user of the first electronic communication device and a second predetermined trigger word from a user of the second electronic communication device.

9. A server for dynamically recording an agreement, comprising:
a memory that stores instructions, and
a processor that processes the instructions, wherein, when executed by the processor, the instructions cause the server to implement a process that includes:
receiving, from a first electronic communication device, a safe word;
receiving, from the first electronic communication device, a voice signature from a user of the first electronic communication device;
sending, to the first electronic communication device, a unique code to display on the first electronic communication device;
receiving, from a second electronic communication device, a scan of the unique code on the first electronic communication device;
receiving, from the second electronic communication device, a voice signature from a user of the second electronic communication device;
initiating audio recording on at least one of the first electronic communication device and the second electronic communication device, and receiving recorded audio of the audio recording;
storing the recorded audio at a central system, and
providing access to the recorded audio.
